(19) United States
(12) Patent Application Publication
(10) Pub. No.: US 2023/0330693 A1
(43) Pub. Date: Oct. 19, 2023

(54) COATING APPARATUS AND METHOD

(71) Applicant: HOMAG GmbH, Schopfloch (DE)

(72) Inventor: BETTERMANN Thomas, Bielefeld (DE)

(21) Appl. No.: 18/022,511

(22) PCT Filed: Aug. 20, 2021
(86) PCT No.: PCT/EP2021/073145

§ 371 Date: Feb. 21, 2023

(30) Foreign Application Priority Data
Aug. 21, 2020 (DE) 10 2020 121 929.6

(51) Int. Cl. B05C 5/02; B27D 5/00; B05C 1/08

(52) U.S. Cl. CPC B05C 5/0204; B27D 5/003; B05C 1/08

(57) ABSTRACT

The invention relates to a coating apparatus that is in particular configured to coat narrow surfaces of a plate-shaped workpiece, and to a method. The coating apparatus comprises a first application device for applying a first coating material to a first narrow surface of the workpiece as well as a second application device for applying a second coating material to a second narrow surface of the workpiece. The coating apparatus furthermore comprises a first printing device for printing the first coating material.

### TECHNICAL FIELD

The invention relates to a coating apparatus that is in particular configured to coat narrow surfaces of a plate-shaped workpiece. The invention furthermore relates to a method.

### PRIOR ART

In industrial furniture manufacturing, plate-shaped workpieces are provided with a coating material, in particular with a so-called edge band, on a narrow surface. In many cases, coating apparatus for applying a coating material are configured such that one narrow surface of a workpiece can be coated per pass. By coating a single narrow surface of a workpiece, it is possible that workpieces with different dimensions can be coated one after the other during operation of the coating apparatus. Corresponding different coating materials are fed from stores. However, if plate-shaped workpieces are provided with a coating material on a plurality of narrow surfaces, several passes are required. As a result, the throughput of such a machine is relatively low, even though the aforementioned approach provides a high degree of flexibility.

This increased flexibility is not always necessary for some furniture manufacturers since lots of workpieces having the same dimensions are processed. In this case, the focus lies more on high throughput to achieve high quantities of items.

### DESCRIPTION OF THE INVENTION

An object forming the basis for the invention is to provide a coating apparatus and a method for coating a workpiece that offers increased flexibility with a high throughput.

Such a coating apparatus is described in claim 1. Further preferred embodiments are specified below or in the dependent claims. The invention furthermore provides a method, with preferred embodiments of the method being described in the dependent method claims. Features of the method claims can each be used individually to further describe a suitability of the apparatus. Features of the apparatus claims can also each be used individually within the context of the method.

The coating apparatus in particular comprises a first application device for applying a first coating material to a first narrow surface of the workpiece and a second application device for applying a second coating material to a second narrow surface of the workpiece. The coating apparatus furthermore comprises a first printing device for printing the first coating material.

The coating apparatus has the advantage that, in addition to a high throughput, each workpiece can be individually processed. It is in particular made possible to change the decorative pattern during operation. However, it is no longer necessary to store large quantities of different coating materials. Rather, a compactly configured coating apparatus with a high degree of flexibility and a high throughput can be provided.

The cited coating material is in particular a strip-shaped coating material that is also referred to as an edge band.

The coating apparatus may comprise a pre-treatment device, in particular comprising a cleaning device, and/or a post-treatment device, in particular comprising a drying device, such as a UV drying device, which are arranged in such a way that the surface to be printed with the printing device or the printed surface can be pre-treated or post-treated.

The first application device and/or the second application device can furthermore be movable along a guide. The coating apparatus can therefore be adjusted for workpieces of different widths or coating materials of different thicknesses. In particular, a drive can be provided to move the first application device and/or the second application device along a guide.

The first application device, the second application device, the first printing device and/or the second printing device may be pivotable, in particular to apply coating material to a side of the workpiece and/or to print the same, the side of the workpiece being inclined. Such a side may, for example, be a narrow side that is inclined at an angle deviating from 90° to the broad side.

It is preferred that the first application device and/or the second application device comprise a pressure roller or a pressure shoe. By means of the pressure roller or a pressure shoe, the coating material can be pressed onto a narrow surface of a workpiece. A shaping roller or shaping shoe may furthermore be used.

According to a further embodiment, it is provided that the first printing device is an inkjet printing device that enables precise ink application. According to one embodiment, it is provided that the first printing device comprises print heads for different colours so that a specific decorative pattern can be printed for each individual workpiece.

The coating apparatus may comprise a first format processing unit, in particular comprising a rotating processing tool, for processing the first coating material applied to the workpiece, and a second format processing unit, in particular comprising a rotating processing tool, for processing the second coating material applied to the workpiece. Furthermore, a trimming unit and a scraper may be provided in each case to trim a coating material provided on the workpiece and to process the transition to the broad side.

The coating apparatus may be configured such that the first printing device is arranged upstream of the first application device in the direction of movement of the first coating material. This arrangement can be used to print the coating material before the coating material is applied to the workpiece. It is in particular provided that the material printed on the coating material, in particular ink, dries during movement of the coating material from the first printing device to the first application device, optionally using a drying device, so that pressing of the printed coating material onto the workpiece by the first application device is ensured without impairing the printed sections.

It may furthermore be provided that the first printing device is arranged downstream of the first application device in the direction of movement of the first coating material. According to this configuration, the coating material is first of all applied to the workpiece and is then subsequently printed by means of the printing device. The printed area can be positioned extremely precisely according to this embodiment.

The coating apparatus may further comprise a second printing device for printing the second coating material. A first coating material and a second coating material can thus accordingly be printed with the first printing device and the second printing device. This enables printing on both sides such that high quantities of items can be produced with a high degree of flexibility.

The second printing device can be configured and/or arranged in the same manner as the first printing device. Reference is also made in this regard to the statements made above with respect to the first printing device.

The second printing device may in particular be an inkjet printing device, it being preferred that the second printing device comprises print heads for different colours.

The second printing device may furthermore be arranged upstream of the second application device in the direction of movement of the second coating material. This arrangement can be used to print the coating material before the coating material is applied to the workpiece. It is in particular provided that the material printed on the coating material, in particular ink, dries during movement from the second printing device to the second application device, optionally using a drying device, so that pressing of the printed coating material onto the workpiece by the second application device is ensured without impairing the printed sections.

According to a further embodiment, the second printing device is arranged downstream of the second application device in the direction of movement of the second coating material. According to this configuration, the coating material is first of all applied to the workpiece and is then subsequently printed by means of the printing device. The printed area can be positioned extremely precisely according to this embodiment.

It is particularly preferred that the first printing device and the second printing device are arranged opposite one another. A precise and simplified coordination of the printing processes can be achieved in this manner, especially if, for example, the printed decorative pattern is supposed to imitate a wood decorative pattern. A decorative pattern is thereby created on the narrow surfaces, which appears as if wood structures, such as grain, knots or annual rings, extend through the workpiece.

According to a further embodiment, it is provided that the first printing device and the second printing device are in fluid connection with a common supply of printing material, in particular ink. Capacities can thus be pooled. It is furthermore ensured that both printing devices are supplied with printing material. Once the supply runs out, a user can be prompted to refill the supply. Furthermore, the common supply has the advantage that differences between batches of printing material (in particular ink) can be avoided, which could arise, for example, due to different storage times. Colour differences are thus avoided.

The first and/or second printing device can be configured to print coating materials of different thickness, cross-sectional shape and/or width. The coating apparatus therefore has a high degree of flexibility.

The coating apparatus may comprise a conveying device, in particular a transport belt, a conveyor chain or a conveyor belt, for moving the workpiece. A high throughput is ensured with such an arrangement.

According to a further embodiment, it is provided that the first application device and the second application device are arranged opposite one another. The workpiece can thus be supported on both sides during the application process.

The first application device and/or the second application device may be movable along a guide. Alternatively, the group consisting of the first printing device and the first application device and/or the group consisting of the second printing device and the second application device may be movable along a respective guide. The coating apparatus can therefore be adjusted to workpieces of different widths. The respective movability can take place by means of a drive.

A method for coating narrow surfaces of a workpiece is furthermore provided, said method comprising the following steps: Applying a first coating material to a first narrow surface of the workpiece, and applying a second coating material to a second narrow surface of the workpiece, with at least the first coating material being printed.

The method has the advantage that, in addition to a high throughput, each workpiece can be individually processed. It is in particular made possible to change the decorative pattern during operation. However, it is no longer necessary to store large quantities of different coating materials.

A coating apparatus according to one of the preceding aspects may be used within the context of the method.

It is preferred that the first narrow surface is arranged opposite the second narrow surface. Coating of a workpiece on both sides can thus take place.

It is furthermore preferred that the method steps are carried out in the cited order.

The method preferably comprises the following step: Format processing, trimming the coating material and/or removing the first coating material applied to the workpiece and the second coating material applied to the workpiece. A high-quality coating can thus be provided.

It is preferred that the first coating material is printed before it is applied to the workpiece and/or that the first coating material is printed after it has been applied to the workpiece.

If the coating material is printed before it is applied to the workpiece, the material printed on the coating material, in particular ink, can dry during movement from the first printing device to the first application device, optionally using a drying device, so that pressing of the printed coating material onto the workpiece is ensured without impairing the printed sections.

If the coating material is printed after it has been applied to the workpiece, the printed area can be positioned extremely precisely.

According to a further embodiment, it is provided that the second coating material is printed. Printing of the second coating material can be carried out in a similar manner to printing of the first coating material. Reference is also made in this regard to the statements made above with respect to the printing of the first coating material.

Within the context of the method, it is possible that the first coating material and the second coating material are the same in terms of colour, pattern, thickness, cross-sectional shape and/or width.

However, the method can also be carried out in such a manner that the first coating material and the second coating material differ in terms of colour, pattern, thickness, cross-sectional shape and/or width. For example, the workpiece may have different narrow sides such that a coating material having a first width is applied to one narrow side and a coating material having a second width is applied to another narrow side. Coating materials may also have different radii or indentations, such that the cross-sectional shape thereof differs.

The method can thus be used in an extremely flexible manner.

It may thereby be provided that printing of a first coating material and a second coating material having the same colour, thickness and/or width is carried out. Flexibility can thus be increased again.

It is in particular preferred that the second coating material is printed before it is applied to the workpiece and/or that the second coating material is printed after it has been applied to the workpiece.

For example, printing of the first coating material and printing of the second coating material can be performed opposite one another. A precise and simplified coordination of the printing processes can be achieved in this manner, especially if, for example, the printed decorative pattern is supposed to imitate a wood decorative pattern. A decorative pattern is thereby created on the narrow surfaces, which appears as if wood structures, such as grain, knots or annual rings, extend through the workpiece.

It is preferred that the workpiece is moved by means of a conveying device. High quantities of items can be processed in this manner.

According to a further embodiment, the workpiece can also be at least temporarily held or fixed. According to this embodiment, an extremely variable production can be implemented.

Furthermore, a first and/or second coating material may be made of a plastic material, or it may be a veneer, preferably a real-wood veneer. It is in particular an edge band material.

The first and/or second coating material may be a fully coloured coating material, with a pattern being applied to the coating material by the first or second printing device.

A workpiece may, for example, be a workpiece made of wood, a wood material or a composite material.

### BRIEF DESCRIPTION OF THE DRAWINGS

Further features and advantages of an apparatus, a use and/or a method are apparent from the following description of embodiments with reference to the accompanying figures.

FIG. 1 shows a perspective view of a first embodiment.

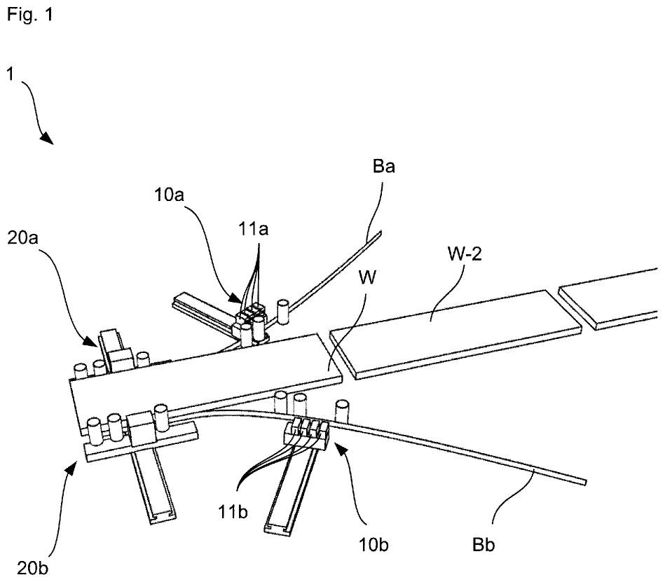

FIG. 2 shows a top view of the first embodiment shown in FIG. 1.

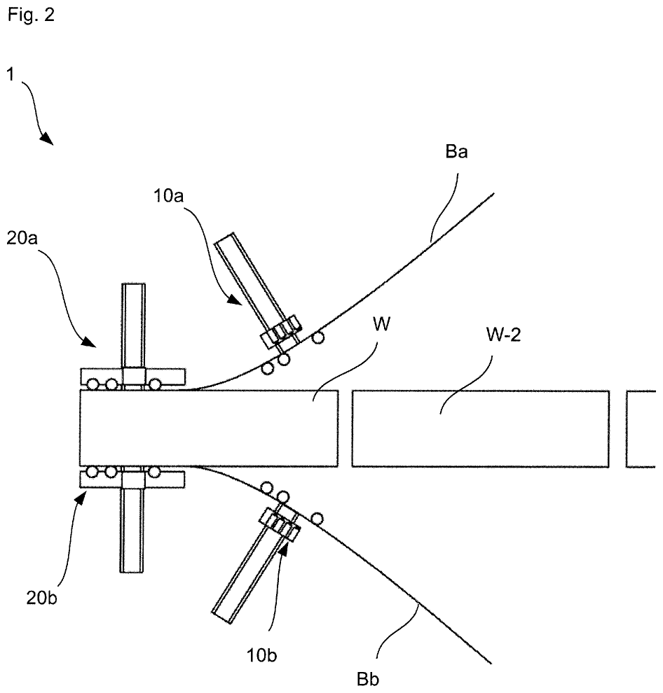

FIG. 3 shows a perspective view of a second embodiment.

FIG. 4 shows a top view of the second embodiment shown in FIG. 3.

### DESCRIPTION OF EMBODIMENTS

Identical reference numbers that are used in different figures designate identical, corresponding or functionally similar elements.

According to the first embodiment, a coating apparatus 1 is provided which is configured as a throughfeed device. The coating apparatus 1 comprises a conveying device (not shown), for example a transport belt, a conveyor belt or a chain conveyor, with which workpieces are moved in a conveying direction. A first workpiece W and a second W-2 are shown for the purpose of illustration in the figures.

The coating apparatus 1 is configured to provide a workpiece with coating material on both sides. For this purpose, the coating apparatus 1 is configured to supply a first coating material Ba and a second coating material Bb and apply them to a workpiece.

The coating apparatus 1 comprises a first printing device 10a, which is arranged such that the first coating material Ba supplied in the direction of the workpiece W can be printed. The printing device 10a is an inkjet printing device comprising a plurality of print heads 11a. The print heads 11a are provided for applying different colours. In particular, one print head should eject the colour black, one print head should eject the colour magenta, one print head should eject the colour yellow and another print head should eject the colour cyan. A multicoloured pattern can be created on the coating material Ba by combining the different colours.

The printing device 10a may comprise a pre-treatment device. A mechanical pre-cleaning and/or primer application may in particular be performed. In this manner, it is possible to produce printed images of excellent quality that are highly durable.

The coating apparatus 1 furthermore comprises a first application device 20a, with which the first coating material Ba can be applied to a first narrow surface of the workpiece. The application device 20a may comprise a pressure roller. Further pressure rollers may also be provided, with which the first coating material Ba applied to the workpiece is pressed onto the workpiece by the application of further force.

The coating apparatus 1 comprises the second printing device 10b, which is arranged such that the second coating material Bb supplied in the direction of the workpiece W can be printed. According to the embodiment, it is provided that the second printing device 10b is configured in a manner similar or identical to the first printing device 10a, the second printing device 10b in particular comprising a plurality of print heads 11b for different colours.

Similar to the printing device 10a, the printing device 10b may comprise a pre-treatment device configured for mechanical pre-cleaning and/or primer application.

The coating apparatus 1 furthermore comprises a second application device 20b for applying the second coating material Bb to a second narrow surface of the workpiece W. The second application device 20b is arranged in such a manner that the second coating material Bb is applied to the workpiece W such that opposite narrow surfaces of the workpiece are coated with the first coating material Ba and the second coating material Bb.

The first application device 20a and/or the second application device 20b is/are movable along a guide perpendicular to the conveying direction of the workpieces W, W-2. The coating apparatus 1 can thus be adjusted to workpieces of different widths. Furthermore, the first application device 20a and/or the second application device 20b may be pivotable to apply a coating material to an inclined narrow side.

The coating apparatus 1 is further equipped with a first trimming unit, a first scraper and/or a first format processing unit (not shown) comprising a rotating processing tool, in particular a milling cutter. The first format processing unit is provided for processing the first coating material Ba applied to the workpiece.

In order to process the second coating material Bb applied to the workpiece, a second trimming unit, a second scraper and/or a second format processing unit (not shown) is provided, which is mounted substantially opposite the first format processing unit. The second format processing unit comprises a rotating processing tool, in particular a milling cutter.

Post-processing of the coating materials can be carried out by means of the format processing units. It is in particular provided to cut off the sections of the coating material projecting in the vertical direction beyond the main surface of the workpiece and thus to create a transition between the coating materials and the main surfaces of the workpiece.

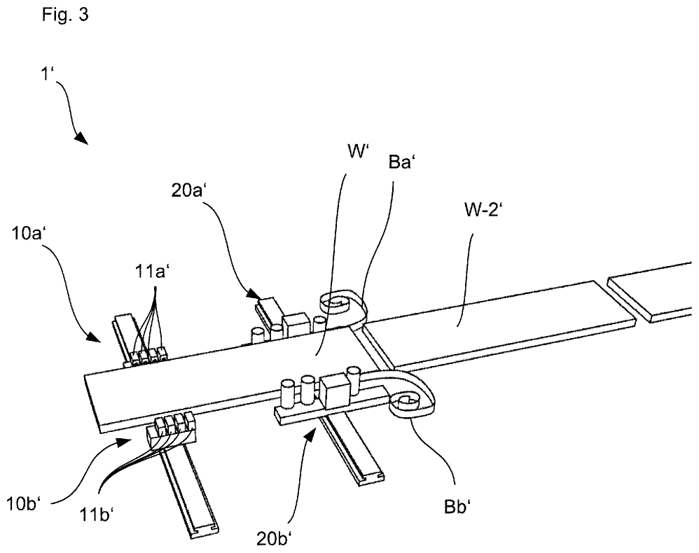

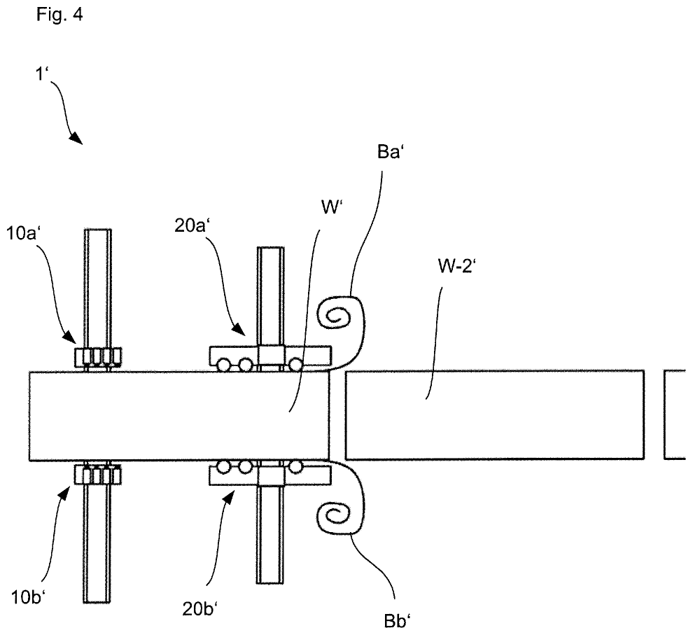

Clearly shown in FIGS. 3 and 4 is a coating apparatus 1′ according to a second embodiment. The coating apparatus 1′ according to the second embodiment differs from the coating apparatus 1 of the first embodiment as regards the arrangement of the application devices and printing devices. As regards the further features, reference is additionally made to the explanations provided with respect to the first embodiment.

The coating apparatus 1′ is designed as a throughfeed machine and is configured to provide a workpiece with coating material on both sides. For this purpose, the coating apparatus 1′ is configured to supply a first coating material Ba′ and a second coating material Bb′ and apply them to a workpiece.

The coating apparatus 1′ comprises a first application device 20a′, with which the first coating material Ba′ can be applied to a first narrow surface of the workpiece W′. The first application device 20a′ may comprise a pressure roller and further pressure rollers with which the first coating material Ba′ applied to the workpiece is pressed onto the workpiece W′ by the application of further force.

The coating apparatus 1′ further comprises a first printing device 10a′, which is arranged such that the first coating material Ba′ attached to the workpiece W′ can be printed. The printing device 10a′ is configured as an inkjet printing device comprising a plurality of print heads 11a′ which, similar to the print heads according to the first embodiment, are provided for applying different colours to produce a multicoloured pattern on the first coating material Ba′.

The coating apparatus 1′ comprises a second application device 20b′ for applying the second coating material Bb′ to a second narrow surface of the workpiece W′, which is arranged substantially opposite the first application device 20a′.

The coating apparatus 1′ furthermore comprises a second printing device 10b′ that is arranged substantially opposite the first printing device 10a′. According to the second embodiment, it is provided that the second printing device 10b′ is configured in a manner similar or identical to the first printing device 10a′, the second printing device 10b in particular comprising a plurality of print heads 11b′ for different colours.

According to the embodiment, the first printing device and the second printing device use a common supply (not shown) of printing material, in particular ink. The first printing device and the second printing device are accordingly in fluid connection with such a supply.

The first printing device 10a′ and the first application device 20a′, and/or the second printing device 10b′ and the second application device 20b, are movable along a respective guide perpendicular to the conveying direction of the workpieces W′, W-2′. The coating apparatus 1′ can therefore be adjusted to workpieces of different widths. Furthermore, the first application device 20a′ and/or the second application device 20b′ may be movable along a guide. The first printing device 10a′, the first application device 20a′, the second printing device 10b′ and/or the second application device 20b may also be pivotable to apply a coating material to an inclined narrow side and/or to print the same.

Similar to the coating apparatus 1 of the first embodiment, the coating apparatus 1′ is provided with format processing units for post-processing the coating materials.

Even though the coating apparatus according to the previously described embodiments is configured as a throughfeed machine in which a workpiece is moved, a coating apparatus can also be configured as a stationary machine in which a workpiece is at least temporarily held or fixed.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A coating apparatus comprising:
a first application device for applying a first coating material to a first narrow surface of a workpiece;
a second application device for applying a second coating material to a second narrow surface of the workpiece; and
a first printing device for printing the first coating material.

2. The coating apparatus according to claim 1, wherein the first application device or the second application device comprises a pressure roller.

3. The coating apparatus according to claim 1, wherein the first printing device is an inkjet printing device.

4. The coating apparatus according to claim 1, further comprising:
a first format processing unit comprising a rotating processing tool for processing the first coating material applied to the workpiece; and
a second format processing unit comprising a rotating processing tool for processing the second coating material applied to the workpiece.

5. The coating apparatus according to claim 1, wherein the first printing device is arranged upstream of the first application device in the direction of movement of the first coating material.

6. The coating apparatus according to claim 1, wherein the first printing device is arranged downstream of the first application device in the direction of movement of the first coating material.

7. The coating apparatus according to claim 1, further comprising a second printing device for printing the second coating material.

8. The coating apparatus according to claim 7, wherein the first printing device and the second printing device are in fluid connection with a common supply of printing material, in particular ink.

9. The coating apparatus according to claim 7, wherein:
the first application device or the second application device is movable along a guide and/or pivotable.

10. The coating apparatus according to claim 1, further comprising a conveying device for moving the workpiece.

11. A coating apparatus according to claim 1, wherein the first application device and the second application device are arranged opposite one another.

12. A method for coating narrow surfaces of a workpiece, comprising the steps of:
applying a first coating material to a first narrow surface of the workpiece; and
applying a second coating material to a second narrow surface of the workpiece,
wherein at least the first coating material is printed.

13. The method according to claim 12, comprising:
format processing, trimming the coating material and/or removing the first coating material applied to the workpiece and the second coating material applied to the workpiece.

14. The method according to claim 12, wherein
the first coating material is printed before it is applied to the workpiece, or
the first coating material is printed after it has been applied to the workpiece.

15. The method according to claim 12, wherein the second coating material is printed.

16. The coating apparatus according to claim 7, wherein:
the first printing device and the first application device or the second printing device and the second application device is movable along a respective guide or pivotable.

17. The coating apparatus according to claim 10, wherein the conveying device comprises a transport belt, a conveyor chain or a conveyor belt.
